(19) United States
(12) Patent Application Publication
(10) Pub. No.: US 2026/0303846 A1
(43) Pub. Date: Oct. 1, 2026

(54) DECODER-SIDE INTRA MODE DERIVATION MERGE IMPROVEMENTS

(71) Applicant: Nokia Technologies Oy, Espoo (FI)

(72) Inventors: Pekka Astola, Tampere (FI); Saverio Blasi, London (GB); Jani Lainema, Tampere (FI)

(21) Appl. No.: 19/489,824

(22) PCT Filed: Jun. 3, 2024
(86) PCT No.: PCT/EP2024/065200

§ 371 Date: Dec. 3, 2025

Related U.S. Application Data
(60) Provisional application No. 63/513,165, filed on Jul. 12, 2023.

(51) Int. Cl. H04N 19/44; H04N 19/11; H04N 19/176

(52) U.S. Cl. CPC H04N 19/44; H04N 19/11; H04N 19/176

(57) ABSTRACT

In accordance with example embodiments of the invention there is at least a method and apparatus to perform determining decoder side intra mode derivation merge information, wherein the determining comprises deriving a histogram of gradients, and wherein the derived histogram of gradients is based on at least angular intra prediction information of different blocks; and based on the decoder side intra mode derivation merge information, predicting at least one sample of values in a given block of samples.

### TECHNICAL FIELD

The teachings in accordance with the exemplary embodiments of this invention relate generally to a new machine learning-dedicated bearer for machine learning or artificial intelligence related data exchange and, more specifically, relate to a new method and apparatus to perform based on exponential scaling that implicitly de-emphasizes further away blocks, allowing larger neighborhoods to be easily used in decoder side intra mode derivation (DIMD) merge.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
AMF access and mobility function
CC cross component
CCLM cross-component linear model
CTU coding tree unit
DIMD decoder side intra mode derivation
ECM exploration coding model
Intra TMP intra template matching prediction
LMF location management function
LUT lookup table
MME mobility management entity
MPM most probable modes
NCE network control element
PCF policy control function
RAN random access network
SGW serving gateway
SMF session management function
TM template matching
UDM unified data management

### BRIEF DESCRIPTION OF PRIOR DEVELOPMENTS

Decoder side intra mode derivation (DIMD) for video codecs uses a method to determine the Intra mode of the current block using directionality of the texture of the neighboring reconstructed samples located in a template region at top, top-left, and left sides of the current block. In DIMD, one (or more) intra modes and their corresponding weight factors are derived first. Then, predictors are generated for these intra modes, and also for the Planar mode. A final intra prediction for the current block is generated by combining these predictors by means of sample-wise or uniform weighting, using the derived weights.

In an existing DIMD method, a DIMD merge produces an intra-prediction for a given block using intra-prediction, where the prediction for the current block is obtained by means of blending a number of predictors obtained with determined intra-prediction modes using determined weights, where the intra prediction modes and weights used to predict the current block are determined by using DIMD process applied to at least one different block. In DIMD merge the intra prediction modes and weights used to predict the current block are obtained as a result of combining the DIMD information (including the histogram of gradients) extracted from a number of neighbouring blocks.

Example embodiments of this invention proposes at least improved decoder side intra mode derivation merge operations.

### SUMMARY

This section contains examples of possible implementations and is not meant to be limiting.

In another example aspect of the invention, there is an apparatus, such as a user equipment side apparatus, comprising: at least one processor; and at least one non-transitory memory storing instructions, that when executed by the at least one processor, cause the apparatus at least to: determine decoder side intra mode derivation merge information, wherein the determining comprises deriving a histogram of gradients, and wherein the derived histogram of gradients is based on at least angular intra prediction information of different blocks; and based on the decoder side intra mode derivation merge information, predict at least one sample of values in a given block of samples.

In still another example aspect of the invention, there is a method, comprising: determining decoder side intra mode derivation merge information, wherein the determining comprises deriving a histogram of gradients, and wherein the derived histogram of gradients is based on at least angular intra prediction information of different blocks; and based on the decoder side intra mode derivation merge information, predicting at least one sample of values in a given block of samples.

A further example embodiment is an apparatus and a method comprising the apparatus and the method of the previous paragraphs, wherein the angular intra prediction information of neighboring blocks used in the derivation of the derived histogram of gradients can be weighted using an exponential or linear model, wherein at least one derived histogram of gradients is used for deriving an angular direction for an intra prediction of at least one sample in a given block, wherein the derived histogram of gradients comprises of amplitudes for at least one angular intra prediction direction wherein the amplitude is derived based on the number of reconstructed samples or blocks using said angular intra prediction direction, wherein at least one derived histogram of gradients is stored for each coding unit, wherein the intra prediction of at least one sample in the given block of samples is derived by using at least one derived histogram of gradients and at least one histogram of gradients, wherein the deriving of the histogram of gradients comprises at least one of an exponential scaling factor or linear model used in weighting of intra prediction information of reconstructed blocks, wherein for at least some different blocks the angular intra prediction information of different blocks is based on the computation of a supporting histogram of gradients to determine one or more dominant angular intra prediction directions, wherein the computation of the derived histogram of gradients comprises scaling based on the size of the current block, wherein the computation of the derived histogram of gradients comprises scaling based on the size of a different block, and/or wherein the computation of the derived histogram of gradients comprises scaling based on the location of a current block or a different block with respect to the location of the current block or the different block.

A non-transitory computer-readable medium storing program code, the program code executed by at least one processor to perform at least the method as described in the paragraphs above.

In yet another example aspect of the invention, there is an apparatus comprising: means for determining a decoder side intra mode derivation merge information, comprising a derived histogram of gradients, wherein the histogram of gradients comprises weights of the neighbouring blocks, and wherein the derived histogram of gradients are based at least on angular intra prediction information of neighboring blocks; and means, based on the decoder side intra mode derivation merge information, for predicting at least one sample value in a given block of samples.

In accordance with the example embodiments as described in the paragraph above, at least the means for determining, deriving, and predicting comprises a network interface, and computer program code stored on a computer-readable medium and executed by at least one processor.

A communication system comprising the user equipment side apparatus performing operations as described above.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows a block diagram of one possible and non-limiting exemplary system in which the example embodiments may be practiced; and

FIG. 2 shows two propagation directions for histograms of gradients (synthetic or actual) in accordance with example embodiments of the disclosure;

FIG. 3 shows a method in accordance with example embodiments of the invention which may be performed by an apparatus, such as an apparatus as shown in FIG. 1.

### DETAILED DESCRIPTION

In example embodiments of this invention there is proposed at least a method and apparatus operating to at least perform based on exponential scaling that implicitly de-emphasizes further away blocks, allowing larger neighborhoods to be easily used in decoder side intra mode derivation (DIMD) merge.

Decoder side intra mode derivation (DIMD) is a method to determine the Intra mode of the current block using directionality of the texture of the neighboring reconstructed samples located in a template region at top, top-left, and left sides of the current block. In DIMD, two (or more) intra modes and their corresponding weight factors are derived first. Predictors are generated for these intra modes, and also for the Planar mode. Then the final prediction for the current block is generated by combining these predictors by means of sample-wise or uniform weighting, using the derived weights.

In DIMD, directionality of texture is derived for each neighboring sample in the template region, using 3×3 neighboring samples of that sample. This derivation is performed in several steps. First, the horizontal and vertical direction strengths (Dx and Dy) are calculated using 3×3 neighbouring samples of the training sample.

To generate an intra predictor in DIMD, the decoder derives two angular intra prediction modes from the reconstructed area around the current block. Two angular intra prediction modes are derived from a histogram of gradient (HoG) built by gathering gradients of every position for the reconstructed area around the current block.

The corresponding region on the Intra prediction mode (angle) is determined using sign of Dx and Dy. The ratio of Dx/Dy is calculated, and the corresponding angle index is determined using the ratio value and a table that maps the ratio to proper angle index. Then the final intra mode for that training sample is determined using the region and derived angle. The amplitude (or importance) of this intra mode is derived as the sum of absolute values of Dx and Dy.

The intra mode (corresponding to a given directionality) and its corresponding amplitude are derived as above for each training sample. These are then collected into a histogram of gradients, namely a histogram collecting for each intra mode the cumulative amplitude of all neighbouring samples with that directionality.

Finally, two or more intra modes are derived from the histogram of gradients, by finding the dominant intra modes, namely the modes with the highest amplitudes in the histogram. The weights of each extracted intra mode are determined based on these amplitudes, where higher amplitudes correspond to higher weights. A fixed weight is typically assigned to the planar mode, which is always blended together with the determined intra modes to form the final DIMD prediction.

DIMD is considered in ECM as an option signalled at the encoder side. In addition, DIMD modes (prior to blending) are also included in the list of Most Probable Modes (MPM) for signalling as individual MPM candidates.

As similarly stated above, a DIMD merge produces an intra-prediction for a given block using intra-prediction, where the prediction for the current block is obtained by means of blending a number of predictors obtained with determined intra-prediction modes using determined weights, where the intra prediction modes and weights used to predict the current block are determined by using DIMD process applied to at least one different block. In DIMD merge the intra prediction modes and weights used to predict the current block are obtained as a result of combining the DIMD information (including the histogram of gradients) extracted from a number of neighbouring blocks.

In DIMD merge the histogram of gradients is stored for all DIMD blocks in order to utilize them for DIMD merge blocks. Additionally, in the DIMD merge process, the histograms of gradients are mixed in a local neighborhood so that further away blocks may have too big emphasis. More importantly, in order to use DIMD merge, the neighboring blocks had to have performed DIMD or DIMD merge so that the histogram of gradients is available.

In example embodiments as in this disclosure variants of DIMD merge is provided. This variant does not require the computation of the histogram of gradients for neighboring blocks but instead derives a synthetic histogram of gradients by consider the prediction information of the local neighborhood.

Additionally, in example embodiments as in this disclosure there is provided a method based on exponential scaling that implicitly de-emphasizes further away blocks allowing larger neighborhoods to be easily used in DIMD merge.

Also, in example embodiments as in this disclosure a directional variants of DIMD merge are provided. This variant propagates the histograms of gradients (both synthetic and actual) along different directions in the 2D image domain.

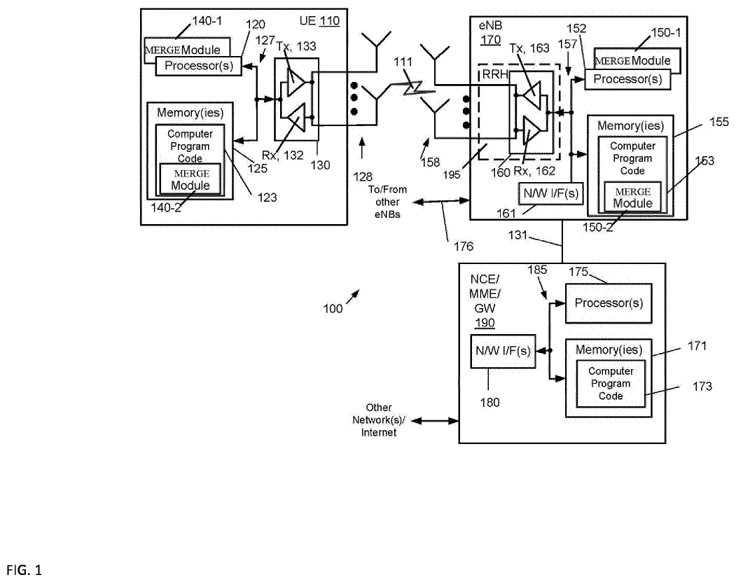

Before describing the example embodiments as disclosed herein in detail, reference is made to FIG. 1 for illustrating a simplified block diagram of various electronic devices that are suitable for use in practicing the example embodiments of this invention.

FIG. 1 is a block diagram of one possible and non-limiting system in which the example embodiments may be practiced.

Turning to FIG. 1, this figure shows a block diagram of one possible and non-limiting example in which the examples may be practiced. A user equipment (UE) 110, and a radio access LTE, 5G, or 6G network base station i.e., gNB 170, and NCE/MME/GW 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a merge module 140, comprising one of or both parts 140-1 and/or 140-2, which may be implemented in a number of ways. The merge module 140 may be implemented in hardware as merge module 140-1, such as being implemented as part of the one or more processors 120. The merge module 140-1 may be implemented also as an integrated circuit or through other hardware such as a programmable gate array. In another example, the merge module 140 may be implemented as merge module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with gNB 170 via a wireless link 111.

The gNB 170 in this example is a base station that provides access by wireless devices such as the UE 110 to the wireless network 100. The gNB 170 may be, for example, a base station for 5G, also called New Radio (NR). In 5G, the gNB 170 may be a NG-RAN node, which is defined as either a gNB or an ng-eNB. A gNB is a node providing NR user plane and control plane protocol terminations towards the UE, and connected via the NG interface to a 5GC (such as, for example, the NCE/MME/GW 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting radio resource control (RRC), SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the gNB 170 and centralized elements of the gNB 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The gNB 170 may also be an eNB (evolved NodeB) base station, for LTE (long term evolution), or any other suitable base station or node.

The gNB 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The gNB 170 includes a merge module 150, comprising one of or both parts 150-1 and/or 150-2, which may be implemented in a number of ways. The merge module 150 may be implemented in hardware as merge module 150-1, such as being implemented as part of the one or more processors 152. The merge module 150-1 may be implemented also as an integrated circuit or through other hardware such as a programmable gate array. In another example, the merge module 150 may be implemented as merge module 150-2, which is implemented as computer program code 153 and is executed by the one or more processors 152. For instance, the one or more memories 155 and the computer program code 153 are configured to, with the one or more processors 152, cause the gNB 170 to perform one or more of the operations as described herein. Note that the functionality of the merge module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 receiverfor gNB implementation for 5G, with the other elements of the gNB 170 possibly being physically in a different location from the RRH/DU, and the one or more buses 157 could be implemented in part as, for example, fiber optic cable or other suitable network connection to connect the other elements (e.g., a central unit (CU), gNB-CU) of the gNB 170 to the RRH/DU 195. Reference 198 also indicates those suitable network link(s).

It is noted that description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. These are merely example functions that may be supported by the NCE/MME/GW 190, and note that both 5G and LTE functions might be supported. The gNB 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, gNB 170, NCE/MME/GW 190, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

One or more of merge modules 140-1, 140-2, 150-1, and 150-2 may be configured to implement high level syntax for a compressed representation of neural networks based on the examples described herein. Computer program code 173 may also be configured to implement high level syntax for a compressed representation of neural networks based on the examples described herein.

In general, various embodiments of any of these devices can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Further, the various embodiments of any of these devices can be used with a UE vehicle, a High Altitude Platform Station, or any other such type node associated with a terrestrial network or any drone type radio or a radio in aircraft or other airborne vehicle or a vessel that travels on water such as a boat.

As similarly stated above, in example embodiments as in this disclosure variants of DIMD merge are provided. This variant does not require the computation of the histogram of gradients for neighboring blocks but instead derives a synthetic histogram of gradients by consider the prediction information of the local neighborhood.

Also as similarly stated above, in example embodiments as in this disclosure there is provided a method based on exponential scaling that implicitly de-emphasizes further away blocks allowing larger neighborhoods to be easily used in DIMD merge.

Further. as similarly stated above, in example embodiments as in this disclosure directional variants of DIMD merge are provided. This variant propagates the histograms of gradients (both synthetic and actual) along different directions in the 2D image domain.

The DIMD's histogram of gradients (HoG) is defined as an array having NUM_LUMA_MODE elements, where in VVC the number of intra luma modes is 67. The HoG is obtained over the intra reference samples by computing horizontal and vertical gradients at each sample location (with the help of a gradient filter) and deriving the four-quadrant tangent which is then mapped into an angular direction. In the end, the HoG will contain the amplitudes for each 67 angular directions and the strongest peaks are considered the (dominant) angular directions of the intra reference samples. The strongest angular directions are then used in the prediction of the given block. In DIMD merge this array of 67 elements is stored for each coding unit and in the merge process the available neighboring HoGs are mixed to provide a more robust and precise estimate of the angular direction.

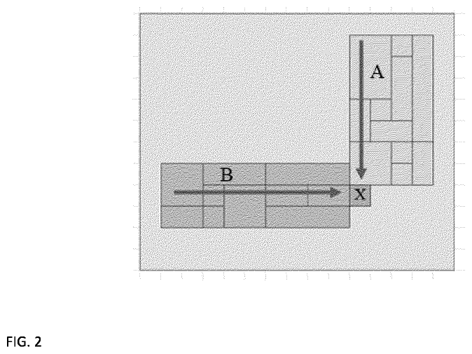

FIG. 2 shows two propagation directions, propagation directions A and B, for histograms of gradients (synthetic or actual). The X block uses DIMD merge and can decide between the two different propagation directions. Essentially this means that the X block can consider two different long term DIMD histograms during the merge process.

Example embodiments as in this disclosure provide a method for deriving a synthetic HoG (SHoG) by considering the angular intra prediction information of neighboring blocks. It is worth mentioning that at least this method can be used in applications where at least one of computation of the gradients or storing of the HoG per CU is prohibited by computational requirements. The steps for obtaining the SHoG are given below:
1. Initialize SHoG[NUM_LUMA_MODE]={0} as an array of zeroes;
2. Scan neighborhood of reconstructed blocks:
   a. For each intra block found, SHoG[ang]+=lumaArea where ang is the angular direction of the found block and lumaArea is the size of the found block.

Since SHoG in essence gives a likelihood (or a probability) for a given angular direction, example embodiments emphasize larger blocks by incrementing with the block size. For intra blocks that do not have an explicitly defined angular intra mode (such as template matched prediction or matrix intra prediction) example embodiments can use the DIMD process to obtain the dominant angular direction of that given block and use that result as ang.

Alternatively, there can be used not only the dominant angular direction (i.e., highest peak in the HoG), but T histogram bins having values larger than zero, where 0<T<NUM_LUMA_MODE. Not all T available peaks need to be considered, there can be considered only the T largest (non-zero) peaks in the HoG. In all such cases the SHoG is incremented for several values of ang and the HoG is obtained so that bin values relate to the number of samples corresponding to a specific angular direction (i.e., a peak in HoG) instead of the gradient magnitudes (as in regular DIMD). In this case the SHoG is obtained in the following way:
1. Initialize SHoG[NUM_LUMA_MODE]={0} as an array of zeroes;
2. Scan neighborhood of reconstructed blocks:
   a. If no angular mode available for the found block:
      i. Perform DIMD on the found block (to obtain HoG)
         1. SHoG[angᵢ]+=HoG[angᵢ]*S where angᵢ is one of the T highest peaks in HoG, HoG has been obtained by incrementing with +1 instead of gradient magnitude, and S=lumaArea/dimdTemplate Area of the found block.
   b. Otherwise
      i. SHoG[ang]+=lumaArea where ang is the angular direction of the found block and lumaArea is the size of the found block.

In an implementation where in step 2.a.1 the HoG is obtained using all samples of the reconstructed block the multiplier S can be omitted if HoG is obtained by incrementing with +1 instead of gradient magnitude.

In accordance with example embodiments as in this disclosure, for intra blocks that use more than one angular intra direction, such as spatial geometric partitioning mode (SGPM), there can be used all N (usually N=2) angular intra directions defined and increment each location in SHoG by lumaArea/N. In a more complex implementation, each bin can be incremented proportionally by the fraction of samples corresponding to each SGPM angular direction.

In accordance with example embodiments as in this disclosure, for DIMD merge, where the HoG and/or ShoG are stored per CU, an exponential scaling parameter called “forgetting factor” can be used to de-emphasize further away information. Essentially, the histograms of gradients are propagated from one block to another block. For example, after computing its own histogram of gradients H0, the current block obtains a neighboring block's histogram of gradients H1. In this case, the final stored histogram of gradients becomes HF=H0+FF*H1, where FF is the forgetting factor and is defined as 0<=FF<=1.0. In the case when H0 is not computed there can still be propagated the histogram and using the forgetting factor to obtain HF=FF*H1. In order to have comparable histograms of gradients between blocks (and between HoGs and SHoGs), DIMD's HoG is normalized using the sum of the HoG. Essentially this means that (during the DIMD process) instead of incrementing the HoG by the gradient filter output, in accordance with example embodiments it is increment by +1. Additionally, in the case when SHoG and HoG are mixed the SHoG is obtained in the following way:
1. Initialize SHoG[NUM_LUMA_MODE]={0} as an array of zeroes;
2. Scan neighborhood of reconstructed blocks:
   a. If no angular mode available for the found block:
      i. Perform DIMD on the found block (to obtain HoG):
         1. SHoG[angᵢ]+=HoG[angᵢ] where angᵢ is one of the T highest peaks in HoG and HoG has been obtained by incrementing with +1 instead of gradient magnitude.
   b. Otherwise:
      i. SHoG[ang]+=dimdTemplateArea where ang is the angular direction of the found block and dimdTemplateArea is the size of the DIMD (reference sample) template of the found block.

In typical image and video content areas of horizontal or vertical nature (such a rectangular areas) can contain different angular directions. For example, a large (multiple CUs) horizontally stretched partition in the image may use horizontal angular directions but a near-by vertically stretched partition may use vertical angular directions, as shown in FIG. 1. A DIMD merge block in the cross-over area of such two different partitions may need to decide between top and left candidate. Therefore, it is beneficial to store two different DIMD merge histograms (synthetic and/or actual), one for the vertical/top direction and one for the horizontal/left direction. For both directions the DIMD histograms of gradients are propagated using forgetting factors to exponentially de-emphasize further away information.

Instead of, or in addition to, an exponential forgetting factor also other kind of forgetting approaches can be used. For example, a linear model can be used to reduce the effect of the further away directionalities to the histogram of gradients for the current block. When using such approach, multiple synthetic or actual histograms of gradients may be collected from blocks with different distances from the current block and those can be scaled using a determined function of distance between the current block and a source block. Alternatively, any non-linear function can be determined to be used to give different weights for histograms of gradients coming from block with different distances from the current block.

In accordance with example embodiments as in this disclosure, the source blocks used in the histogram of gradient generation can be either earlier coding blocks, prediction blocks or transform blocks from the same picture or different reference pictures stored in a reference picture buffer of a video encoder or decoder.

The source blocks used in the histogram of gradient generation do not need to be earlier coding blocks, prediction blocks or transform blocks, but those blocks can be determined based on the location and size of the current block. For example, for a current block with a width of M and height of N samples, two source blocks above the block, both with size of M×2 samples and with distances of zero samples and two samples from the top border of the current block may be selected. Similarly, in accordance with example embodiments there may be defined two source blocks left of the current block, both with sizes of 2×N samples and with distances of zero samples and two samples from the left border of the current block. In this example, the histograms of gradients obtained for the blocks with distance of zero may be weighted with a factor of 1 and the histograms of gradients obtained for the blocks with distance of two samples may be weighted with a forgetting factor FF with 0<=FF<=1.0. Similarly, other number of source blocks with different sizes, shapes and distances can be determined with each having its own forgetting factor.

In an embodiment as in the disclosure, the synthetic histogram of gradients can be mixed with the actual histogram of gradients during the DIMD merge process.

In an embodiment as in the disclosure, the synthetic histogram of gradients can be increment by a scalar such as the block size or block distance from the current block. A mixture of the two methods can also be used.

In an embodiment as in the disclosure, the synthetic histogram of gradients can be increment by a scalar that is derived from the current block's DIMD estimate and the neighboring block's angular direction. For example, if the difference between the current block's DIMD estimate and the neighboring block's angular direction is large (or small) then use smaller (or larger) scalar in incrementing the given angular direction in the synthetic histogram of gradients.

In an embodiment as in the disclosure, when populating the synthetic histogram of gradients, DIMD process can be used to obtain angular the intra direction for blocks using non-angular prediction (such as template matching, intra-block copy or matrix intra prediction).

In an embodiment as in the disclosure, more than one DIMD histogram (at least one of synthetic or actual) can be stored per CU, with each histogram corresponding to a different direction in the image. For example, one histogram is obtained from blocks to the left of the current block, and one histogram is obtained from blocks above the current block.

In an embodiment as in the disclosure, both the synthetic and actual DIMD histograms can be stored per CU.

In an embodiment as in the disclosure, where one or more DIMD histograms are stored, an exponential scaling factor, known as forgetting factor, can be used in conjunction with the neighboring DIMD histograms to accumulate long term histograms of gradients.

In an embodiment as in the disclosure, a chroma block may use its co-located luma block's histogram(s) of gradients (at least one of synthetic or actual).

In an embodiment as in the disclosure, the above methods can also be used for chroma blocks.

In another embodiment as in the disclosure, the forgetting factor can be implement using fixed point arithmetic or floating point arithmetic.

In still another embodiment as in the disclosure, the scaling and normalization of the histograms can be implement using fixed point arithmetic or floating point arithmetic.

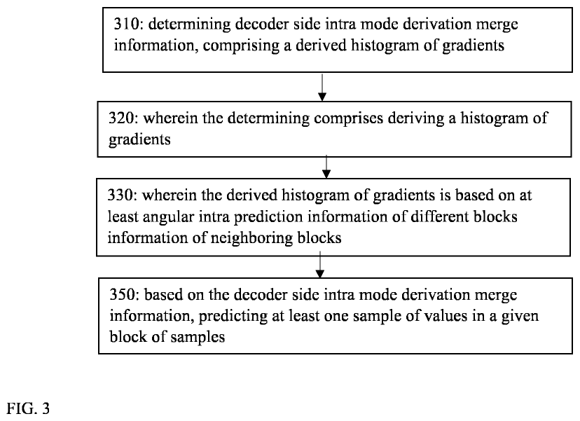

FIG. 3 illustrates operations which may be performed by a device such as, but not limited to, a device such as network node (e.g., the UE 10 as in FIG. 1). As shown in block 310 of FIG. 3 there is determining decoder side intra mode derivation merge information. As shown in block 320 of FIG. 3 wherein the determining comprises deriving a histogram of gradients. As shown in block 330 Of FIG. 3 wherein the derived histogram of gradients is based on at least angular intra prediction information of different blocks. Then as shown in block 340 of FIG. 3 there is based on the decoder side intra mode derivation merge information, predicting at least one sample of values in a given block of samples.

In accordance with the example embodiments as described in the paragraph above, wherein the angular intra prediction information of neighboring blocks used in the derivation of the derived histogram of gradients can be weighted using an exponential or linear model.

In accordance with the example embodiments as described in the paragraphs above, wherein at least one derived histogram of gradients is used for deriving an angular direction for an intra prediction of at least one sample in a given block.

In accordance with the example embodiments as described in the paragraphs above, wherein the derived histogram of gradients comprises of amplitudes for at least one angular intra prediction direction wherein the amplitude is derived based on the number of reconstructed samples or blocks using said angular intra prediction direction.

In accordance with the example embodiments as described in the paragraphs above, wherein at least one derived histogram of gradients is stored for each coding unit.

In accordance with the example embodiments as described in the paragraphs above, wherein the intra prediction of at least one sample in the given block of samples is derived by using at least one derived histogram of gradients and at least one histogram of gradients.

In accordance with the example embodiments as described in the paragraphs above, wherein the deriving of the histogram of gradients comprises at least one of an exponential scaling factor or linear model used in weighting of intra prediction information of reconstructed blocks.

In accordance with the example embodiments as described in the paragraphs above, where for at least some different blocks the angular intra prediction information of different blocks is based on the computation of a supporting histogram of gradients to determine one or more dominant angular intra prediction directions.

In accordance with the example embodiments as described in the paragraphs above, where the computation of the derived histogram of gradients comprises scaling based on the size of the current block.

In accordance with the example embodiments as described in the paragraphs above, where the computation of the derived histogram of gradients comprises scaling based on the size of a different block.

The apparatus of any preceding claim, wherein the computation of the derived histogram of gradients comprises scaling based on the location of a current block or a different block with respect to the location of the current block or the different block.

A non-transitory computer readable medium [Memory(ies) 125 as in FIG. 1 encoded with a computer program [computer program code 123 and/or merge module 140] as in FIG. 1 to perform the operations as at least described in the paragraphs above.

In accordance with an example embodiment of the invention as described above there is an apparatus comprising: means for determining (receiver, Rx, 132 and transmitter, Tx, 133; processors 120 and/or merge module 140-1; Memory(ies) 125; computer program code 123 and/or merge module 140-2 as in FIG. 1) decoder side intra mode derivation merge information, comprising a derived (receiver, Rx, 132 and transmitter, Tx, 133; processors 120 and/or merge module 140-1; Memory(ies) 125; computer program code 123 and/or merge module 140-2 as in FIG. 1) histogram of gradients, wherein the derived histogram of gradients based on at least angular intra prediction information of different blocks; and means, based on the decoder side intra mode derivation merge information, for predicting (receiver, Rx, 132 and transmitter, Tx, 133; processors 120 and/or merge module 140-1; non-transitory computer readable medium Memory(ies) 125]; computer program code 123 and/or merge module 140-2 as in FIG. 1) at least one sample of values in a given block of samples.

In the example aspect of the invention according to the paragraph above, wherein at least the means for determining, deriving, and predicting comprises a non-transitory computer readable medium [Memory(ies) 125 as in FIG. 1] encoded with a computer program [computer program code 123 and/or merge module 140-2 as in FIG. 1.

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.”This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of example embodiments of this invention will still fall within the scope of this invention.

It should be noted that the terms “connected,” “coupled,” or any variant thereof, mean any connection or coupling, either direct or indirect, between two or more elements, and may encompass a presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1-22. (canceled)

23. An apparatus, comprising:
at least one processor; and
at least one memory storing instructions, that when executed by the at least one processor, cause the apparatus at least to:
determine decoder side intra mode derivation merge information,
wherein the determining comprises deriving a histogram of gradients, and
wherein the derived histogram of gradients is based at least on angular intra prediction information of a number of reconstructed blocks; and
predict at least one sample of values in a given block of samples based on the decoder side intra mode derivation merge information.

24. The apparatus of claim 23, wherein the angular intra prediction information used in derivation of the derived histogram of gradients can be weighted using an exponential or linear model.

25. The apparatus of claim 23, wherein at least one derived histogram of gradients is used for deriving an angular direction for an intra prediction of at least one sample in a given block.

26. The apparatus of claim 23, wherein the derived histogram of gradients comprises amplitudes for at least one angular intra prediction direction, and wherein the amplitude is derived based on a number of reconstructed samples or blocks using said at least one angular intra prediction direction.

27. The apparatus of claim 23, wherein at least one derived histogram of gradients is stored for each coding unit.

28. The apparatus of claim 25, wherein the intra prediction of at least one sample in the given block of samples is derived by using the at least one derived histogram of gradients and at least one histogram of gradients.

29. The apparatus of claim 23, wherein the deriving of the histogram of gradients comprises at least one of an exponential scaling factor or linear model used in weighting of intra prediction information of reconstructed blocks.

30. The apparatus of claim 23, wherein for at least some different blocks the angular intra prediction information of the reconstructed blocksis based on computation of a supporting histogram of gradients to determine one or more dominant angular intra prediction directions.

31. The apparatus according to claim 23, wherein computation of the derived histogram of gradients comprises scaling based on a size of a current block.

32. The apparatus according to claim 23, wherein computation of the derived histogram of gradients comprises scaling based on a size of a different block.

33. The apparatus according to claim 31, wherein the computation of the derived histogram of gradients comprises scaling based on a location of the current block or a different block with respect to the location of the current block or the different block.

34. A method, comprising:
determining decoder side intra mode derivation merge information,
wherein the determining comprises deriving a histogram of gradients, and
wherein the derived histogram of gradients is based at least on angular intra prediction information of a number of reconstructed blocks; and
predicting at least one sample of values in a given block of samples based on the decoder side intra mode derivation merge information.

35. The method of claim 34, wherein angular intra prediction information of neighboring blocks used in derivation of the derived histogram of gradients can be weighted using an exponential or linear model.

36. The method of claim 34, wherein at least one derived histogram of gradients is used for deriving an angular direction for an intra prediction of at least one sample in a given block.

37. The method of claim 34, wherein the derived histogram of gradients comprises of amplitudes for at least one angular intra prediction direction wherein the amplitude is derived based on a number of reconstructed samples or blocks using said at least one angular intra prediction direction.

38. The method of claim 34, wherein at least one derived histogram of gradients is stored for each coding unit.

39. The method of claim 36, wherein the intra prediction of at least one sample in the given block of samples is derived by using the at least one derived histogram of gradients and at least one histogram of gradients.

40. The method of claim 34, wherein the deriving of the histogram of gradients comprises at least one of an exponential scaling factor or linear model used in weighting of intra prediction information of reconstructed blocks.

41. The method of claim 34, wherein for at least some different blocks the angular intra prediction information of reconstructed blocksis based on computation of a supporting histogram of gradients to determine one or more dominant angular intra prediction directions.

42. The method according to claim 34, wherein computation of the derived histogram of gradients comprises scaling based on a size of a current block.
